(19) United States
(12) Patent Application Publication
(10) Pub. No.: US 2014/0239206 A1
(43) Pub. Date: Aug. 28, 2014

(54) Stereoscopic Optical System

(71) Applicants: Olympus Corporation, Tokyo (JP); Olympus Medical Systems Corp., Tokyo (JP)

(72) Inventors: Yasushi Namii, Tokyo (JP); Ikutoshi Fukushima, Tokyo (JP)

(21) Appl. No.: 14/178,620

(22) Filed: Feb. 12, 2014

Related U.S. Application Data
(63) Continuation of application No. PCT/JP2013/072538, filed on Aug. 23, 2013.

(30) Foreign Application Priority Data
Sep. 7, 2012 (JP) 2012-197476

(51) Int. Cl. H04N 13/02; G02B 27/22

(52) U.S. Cl. CPC H04N 13/0217; G02B 27/22
USPC 250/558

(57) ABSTRACT

A stereoscopic optical system includes: two objective optical systems arrayed parallel to each other with a space therebetween; two parallelogram prisms that bring optical images close to each other by respectively deflecting lights collected by the objective optical systems twice; an image pickup element arranged at image formation positions of the light fluxes collected by the objective optical systems to take the two optical images brought close to each other by the prisms; and a diaphragm member that blocks a portion of the light flux on at least one of an inner side and an outer side in a direction of the space at any position apart from a pupil position of each of the objective optical systems in a direction of an optical axis, wherein the diaphragm member is arranged on the inner side in the direction of the space, and satisfies a conditional expression L0−Ihy−W>Z0×sin θ.

### CROSS REFERENCE TO RELATED APPLICATIONS

This is a continuation of International Application PCT/JP2013/072538, with an international filing date of Aug. 23, 2013, which is hereby incorporated by reference herein in its entirety. This application claims the benefit of Japanese Patent Application No. 2012-197476, the contents of which are incorporated herein by reference.

### TECHNICAL FIELD

The present invention relates to a stereoscopic optical system.

### BACKGROUND ART

Conventionally, there has been known a stereoscopic optical system which forms two right and left optical images formed by two objective optical systems on one image pickup element (e.g., see Patent Literature 1). The stereoscopic optical system forms two optical images on a single CCD by deflecting lights collected by the two right and left objective optical systems twice respectively by parallelogram prisms and thereby bringing optical axes close to each other.

### CITATION LIST

### Patent Literature

{PTL 1}

Japanese Unexamined Patent Application, Publication No. 2001-75011

### SUMMARY OF INVENTION

### Solution to Problem

One aspect of the present invention provides a stereoscopic optical system including: two objective optical systems that are arrayed parallel to each other with a space therebetween to collect a light from an object side; two parallelogram prisms that bring optical images close to each other by respectively deflecting the lights collected by the objective optical systems twice; an image pickup element that is arranged at image formation positions of the light fluxes collected by the objective optical systems to take the two optical images brought close to each other by the parallelogram prisms; and a diaphragm member that blocks a portion of the light flux on at least one of an inner side and an outer side in a direction of the space between the objective optical systems at any position apart from a pupil position of each of the objective optical systems in a direction of an optical axis, wherein the diaphragm member is preferably arranged on the inner side in the direction of the space between the objective optical systems, and satisfies a following conditional expression:

L0−Ihy−W>Z0×sin θ

where L0 is a bend distance of the light flux by the parallelogram prism, Ihy is an image height at an image pickup surface of the image pickup element, W is an opening width from the optical axis to an opening edge in the diaphragm member, Z0 is a distance from the diaphragm member to the image pickup surface in the direction of the optical axis, and θ is an angle formed between a line and the optical axis, the line connecting the pupil position and the image height of the optical image at the image pickup surface.

### BRIEF DESCRIPTION OF DRAWINGS

FIG. 1 is a front view illustrating a stereoscopic optical system according to one embodiment of the present invention.

FIG. 2 is a view illustrating an arrangement example of optical images formed on an image pickup element of the stereoscopic optical system in FIG. 1.

FIG. 3 is a partially enlarged view illustrating an arrangement example of a diaphragm member of the stereoscopic optical system in FIG. 1.

FIG. 4 is a partially enlarged view illustrating another arrangement example of the diaphragm member of the stereoscopic optical system in FIG. 1.

FIG. 5 is a front view illustrating a modification of the stereoscopic optical system in FIG. 1.

FIG. 6 is a front view illustrating a light blocking member provided on the image pickup element as another modification of the stereoscopic optical system in FIG. 1.

FIG. 7 is a view illustrating the arrangement of the light blocking member in FIG. 6 on the image pickup element.

### DESCRIPTION OF EMBODIMENTS

A stereoscopic optical system 1 according to one embodiment of the present invention is described below by reference to the drawings.

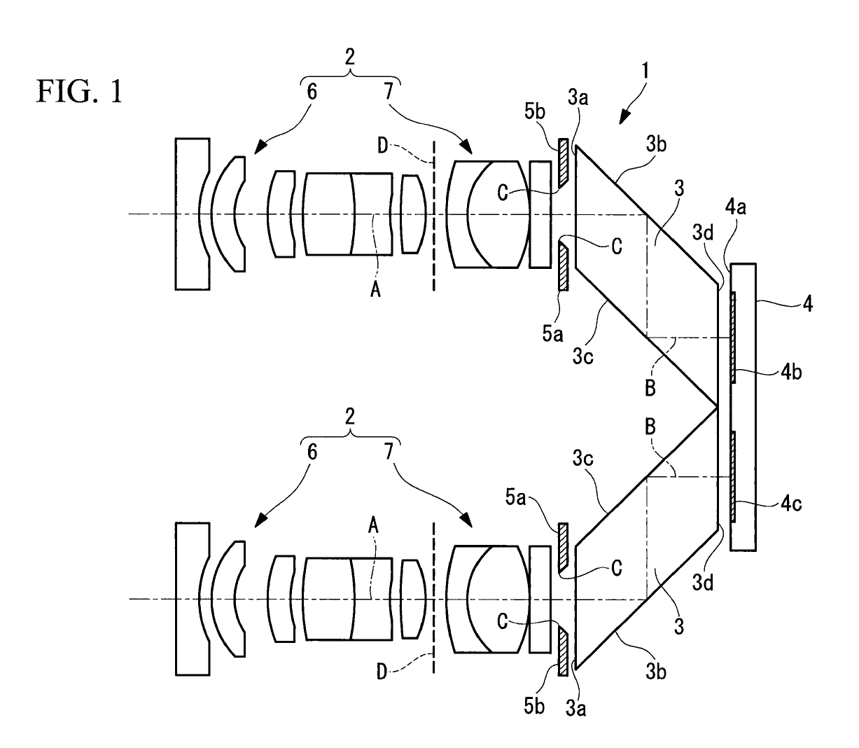

The stereoscopic optical system 1 according to the present embodiment includes two objective optical systems 2 that are arrayed parallel to each other with a space therebetween, two parallelogram prisms 3 that are arranged downstream of the objective optical systems 2, one image pickup element 4 that is arranged downstream of the parallelogram prisms 3, and diaphragm members 5a and 5b as shown in FIG. 1.

Each of the objective optical systems 2 includes a first group 6 having a negative refractive force, and a second group 7 having a positive refractive force sequentially from an object side. A light flux collected by the objective optical system 2 is reduced in diameter and then spread by the first group 6, and collected again to form an image at a focal position by the second group 7. The focal position of the second group 7 is matched with an image pickup surface 4a of the image pickup element 4 described below.

Each of the parallelogram prisms 3 includes a first surface 3a that is arranged perpendicular to an optical axis (incident optical axis) A of the objective optical system 2 such that the light exiting from the second group 7 of the objective optical system 2 enters into the parallelogram prism 3, a second surface 3b that is arranged at an angle of 45° with respect to the optical axis A of the objective optical system 2 so as to deflect the light entering into the parallelogram prism 3 from the first surface 3a, a third surface 3c that is arranged parallel to the second surface 3b, and a fourth surface 3d that is arranged parallel to the first surface 3a. The light entering into the parallelogram prism 3 from the first surface 3a along the incident optical axis A is caused to exit toward the downstream image pickup element 4 from the fourth surface 3d along an outgoing optical axis B parallel to the incident optical axis A after being deflected twice at the second surface 3b and the third surface 3c.

At this time, by arranging the two parallelogram prisms 3 such that a space between the outgoing optical axes B is smaller than a space between the incident optical axes A, optical images collected by the two objective optical systems 2 and formed on the image pickup surface 4a of the image pickup element 4 can be brought close to each other. The size of the image pickup surface 4a of the image pickup element 4 that acquires the two optical images at the same time can be thereby made smaller.

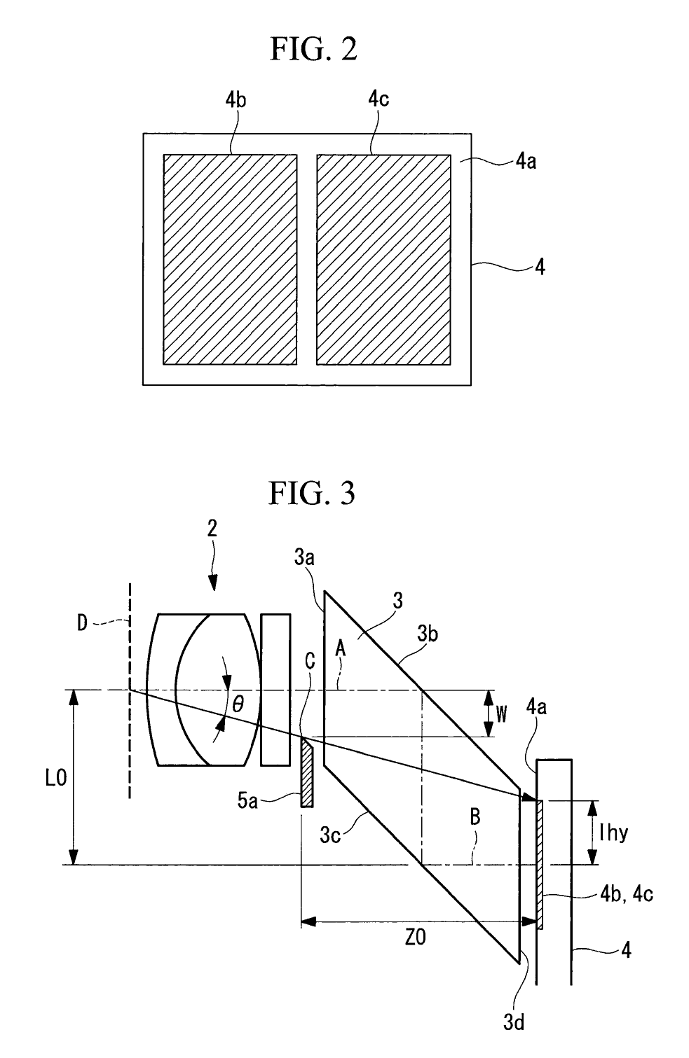

The image pickup element 4 is, for example, a CCD. As shown in FIGS. 1 and 2, the two optical images respectively collected by the objective optical systems 2 are formed side by side on two light receiving regions 4b and 4c of the image pickup surface 4a.

In the present embodiment, the diaphragm members 5a and 5b are arranged between the second group 7 of the objective optical system 2 and the first surface 3a of the parallelogram prism 3.

The diaphragm members 5a and 5b are arranged with opening edges C projecting toward the optical axis A from an inner side and an outer side in the direction of the space between the two objective optical systems 2 that are arrayed with the space therebetween.

The diaphragm members 5a and 5b arranged on the inner side in the direction of the space are arranged at a position satisfying a following conditional expression (1) as shown in FIG. 3.

That is,

L0−Ihy−W>Z0×sin θ (1)

where L0 is a bend distance of the light flux by the parallelogram prism 3, Ihy is an image height of the optical image at the image pickup surface 4a of the image pickup element 4, W is an opening width from the optical axis A to the opening edge C in the diaphragm member 5a, Z0 is a distance from the diaphragm member 5a to the image pickup surface 4a in the direction of the optical axis A, and θ is an angle formed between a line connecting a pupil position D and the image height of the optical image at the image pickup surface 4a, and the optical axis A.

The light entering into the parallelogram prism 3 is restricted on the inner side in the direction of the space between the objective optical systems 2 so as to satisfy the conditional expression (1). The light exiting from the objective optical system 2 and entering into the first surface 3a of the parallelogram prism 3 can be thereby prevented from exiting outside of the parallelogram prism 3 directly from the fourth surface 3d without passing through the second surface 3b and the third surface 3c.

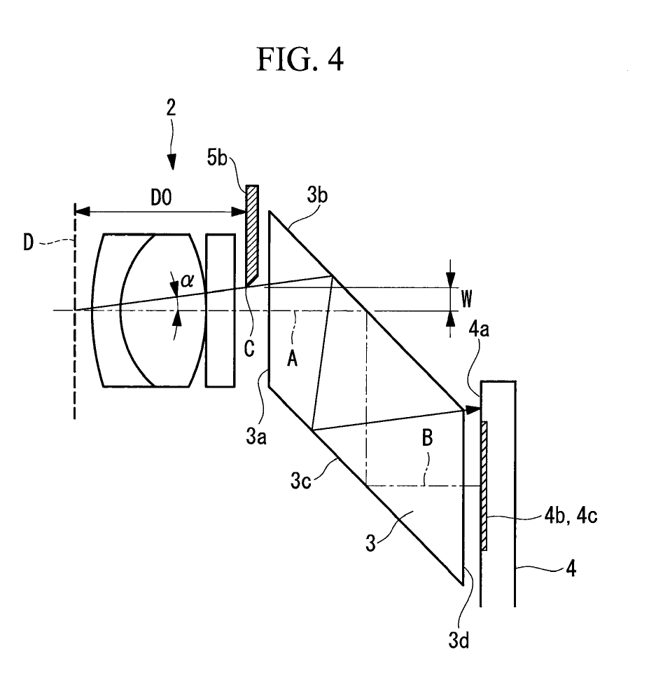

Also, the diaphragm member 5b arranged on the outer side in the direction of the space are arranged at a position satisfying a following conditional expression (2) as shown in FIG. 4.

That is,

W<D0×sin θ (2)

where W is an opening width from the optical axis A to the opening edge C in the diaphragm member 5b, D0 is a distance from the pupil position D to the diaphragm member 5b in the direction of the optical axis, and α is an angle formed between a light flux deflected twice within the parallelogram prism 3 from a corner on the outer side in the direction of the space in the fourth surface 3d of the parallelogram prism 3 and passing through the pupil position D, and the optical axis A.

The light entering into the parallelogram prism 3 is restricted on the outer side in the direction of the space between the objective optical systems 2 so as to satisfy the conditional expression (2). The light exiting from the objective optical system 2 and entering into the first surface 3a of the parallelogram prism 3 can be thereby caused to exit outside of the parallelogram prism 3 from the fourth surface 3d after being reflected once at the second surface 3b and once at the third surface 3c.

That is, in the stereoscopic optical system 1 according to the present embodiment, only the light reflected twice within the parallelogram prism 3 out of the light entering into the parallelogram prism 3 can be caused to enter into the image pickup element 4. Accordingly, the occurrence of an optical image (ghost) entering into the image pickup element 4 after being reflected other than twice can be reliably prevented. Since the diaphragm members 5a and 5b are also arranged immediately before the first surface 3a of the parallelogram prism 3 into which the light from the objective optical system 2 enters, the occurrence of the ghost can be more reliably prevented.

In the stereoscopic optical system 1 according to the present embodiment, the diaphragm members 5a and 5b are arranged on both the inner side and the outer side in the direction of the space of the optical axis A of the objective optical system 2. Accordingly, a ghost (non-reflected ghost) formed by entering into the image pickup element 4 without being reflected even once within the parallelogram prism 3, and a ghost (ghost reflected three or more times) formed by entering into the image pickup element 4 after being reflected three or more times within the parallelogram prism 3 can be both prevented respectively as shown in FIGS. 3 and 4.

Instead, the diaphragm members 5a and 5b may be arranged on only one of the inner side and the outer side. The occurrence of one of the ghosts described above can be thereby prevented.

Moreover, a in the conditional expression (2) may be set to an angle formed between a light flux deflected once within the parallelogram prism 3 from a corner on the inner side in the direction of the space in the first surface 3a of the parallelogram prism 3 and passing through the pupil position D, and the optical axis A.

Accordingly, a ghost (ghost reflected three times) occurring when the light entering from the first surface 3a of the parallelogram prism 3 is reflected at the second surface 3b, reflected again on the inner side of the first surface 3a, then reflected at the third surface 3c, and enters into the image pickup element 4 can be prevented.

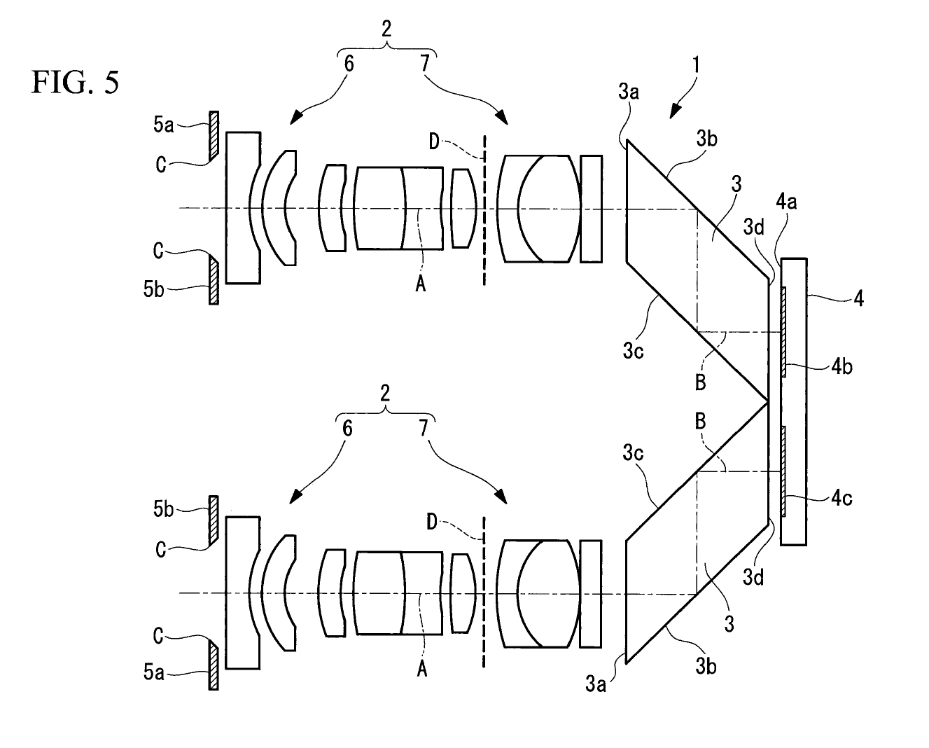

In the present embodiment, the diaphragm members 5a and 5b are arranged between the objective optical system 2 and the parallelogram prism 3. Instead, the diaphragm members 5a and 5b may be arranged on the object side of the objective optical system 2 as shown in FIG. 5. In this case, the non-reflected ghost can be prevented by arranging the diaphragm member 5a on the outer side in the direction of the space between the objective optical systems 2, and the ghost reflected three or more times can be prevented by arranging the diaphragm member 5b on the inner side in the direction of the space between the objective optical systems 2.

The positions of the diaphragm members 5a and 5b are not limited to the aforementioned positions, and the diaphragm members 5a and 5b may be arranged at any positions apart from the pupil position D of the objective optical system 2 in the direction of the optical axis A. In this case, the sectional shape of the light flux approaches the shape of the optical image as the light flux comes closer the object position or the image formation position away from the pupil position D. Thus, the diaphragm members 5a and 5b are preferably arranged at the positions since a required light is not blocked and a peripheral light intensity within an image pickup range can be ensured.

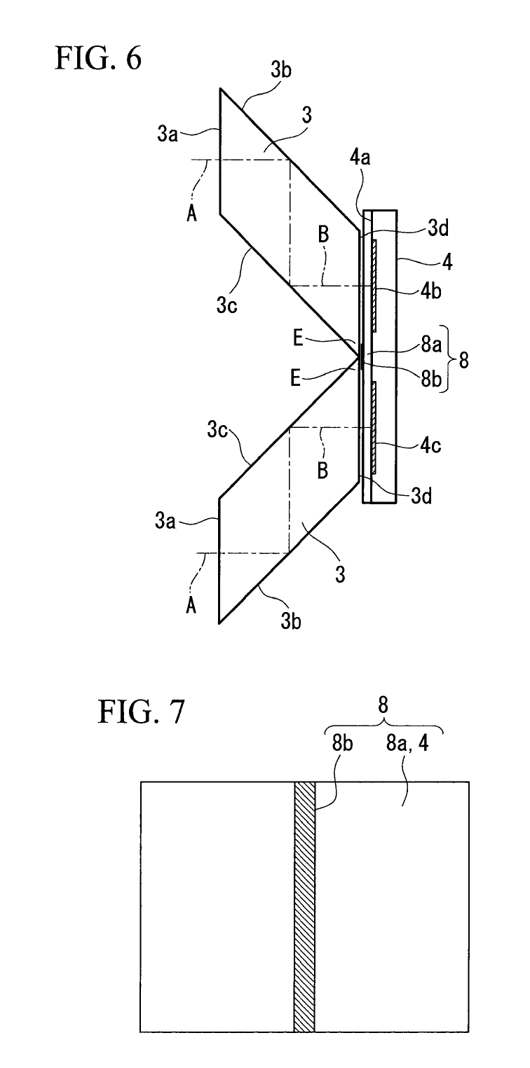

Also, a light blocking member 8 that covers a gap between corner portions E on the inner side in the direction of the space between the objective optical systems 2 in the fourth surfaces 3d of the parallelogram prisms 3 opposing the image pickup element 4, and the image pickup element 4 so as to block the gap may be arranged as shown in FIGS. 6 and 7. When the light propagating within the parallelogram prism 3 enters into the corner portion E, the light becomes flare light reflected in an unexpected direction. Thus, the flare light can be prevented from entering into the image pickup element 4 by covering the corner portions E with the light blocking member 8.

A member obtained by depositing a coating 8b that absorbs light on a plate 8a made of a transparent material covering the image pickup surface 4a of the image pickup element 4 is preferably employed as the light blocking member 8. Accordingly, the image pickup element 4 to which the light blocking member 8 is attached and the fourth surfaces 3d of the parallelogram prisms 3 can be fixed by bonding or the like. Thus, a special fixing member is not required.

The following aspects of the invention are derived from the above embodiment. One aspect of the present invention provides a stereoscopic optical system including: two objective optical systems that are arrayed parallel to each other with a space therebetween to collect a light from an object side; two parallelogram prisms that bring optical images close to each other by respectively deflecting the lights collected by the objective optical systems twice; an image pickup element that is arranged at image formation positions of the light fluxes collected by the objective optical systems to take the two optical images brought close to each other by the parallelogram prisms; and a diaphragm member that blocks a portion of the light flux on at least one of an inner side and an outer side in a direction of the space between the objective optical systems at any position apart from a pupil position of each of the objective optical systems in a direction of an optical axis, wherein the diaphragm member is preferably arranged on the inner side in the direction of the space between the objective optical systems, and satisfies a following conditional expression:

L0−Ihy−W>Z0×sin θ

where L0 is a bend distance of the light flux by the parallelogram prism, Ihy is an image height at an image pickup surface of the image pickup element, W is an opening width from the optical axis to an opening edge in the diaphragm member, Z0 is a distance from the diaphragm member to the image pickup surface in the direction of the optical axis, and θ is an angle formed between a line and the optical axis, the line connecting the pupil position and the image height of the optical image at the image pickup surface.

In accordance with the present aspect, the light from the object side is collected by the objective optical systems parallel to each other with the space therebetween, and the two optical images having a disparity are thereby formed on the image pickup element. Thus, the object can be viewed stereoscopically by separately observing the images with right and left eyes. The lights collected by the two objective optical systems are deflected twice by the parallelogram prisms that are respectively arranged downstream of the objective optical systems, and enter into the image pickup element with their optical axes brought close to each other. Accordingly, the small image pickup element can acquire the two images at the same time, and the system can be thereby made compact.

In this case, the diaphragm member arranged at any position apart from the pupil position of each of the objective optical systems in the direction of the optical axis blocks a portion of the light flux on at least one of the inner side and the outer side in the direction of the space between the objective optical systems. Thus, a light entering into the image pickup element after being reflected other than twice within the parallelogram prism is reduced, so that the occurrence of a ghost can be decreased. Additionally, the occurrence of a ghost can be decreased by preventing the light entering from the objective optical system from reaching the image pickup element without being reflected even once within the parallelogram prism. Accordingly, a clear stereoscopic image can be acquired.

In the above aspect, the diaphragm member may block a light entering at an angle equal to or more than a half view angle of 25°.

Accordingly, an image with a half view angle of about 25° can be obtained. A light entering at an angle equal to or more than 25° is blocked, so that the occurrence of a ghost can be decreased.

In the above aspect, the diaphragm member is preferably arranged on the outer side in the direction of the space between the objective optical systems, and satisfies a following conditional expression:

W<D0×sin θ

where W is an opening width from the optical axis to an opening edge in the diaphragm member, D0 is a distance from the pupil position to the diaphragm member in the direction of the optical axis, and α is an angle formed between a light flux and the optical axis, the light flux being deflected twice within the parallelogram prism from a corner on the outer side in the direction of the space in a surface of the parallelogram prism opposing the image pickup element and passing through the pupil position.

Accordingly, the occurrence of a ghost can be decreased by preventing the light entering from the objective optical system from reaching the image pickup element after being reflected three or more times within the parallelogram prism.

In the above aspect, a light blocking member that covers end edges of the two parallelogram prisms adjacent to each other in a substantially center of the image pickup element against the image pickup surface of the image pickup element may be provided.

Accordingly, flare light generated at the end edges of the parallelogram prisms can be blocked by the light blocking member, and thereby prevented from entering into the image pickup surface of the image pickup element.

In the above aspect, the light blocking member may be formed by depositing a coating made of a material absorbing light on a surface of a plate made of a transparent material that is bonded so as to cover the image pickup surface of the image pickup element.

Accordingly, the light blocking member can be formed only by depositing the coating on the transparent plate, and the light blocking member formed as described above can be bonded to the parallelogram prisms. Thus, a special support member is not required.

### {Reference Signs List}

1 Stereoscopic optical system
2 Objective optical system
3 Parallelogram prism
4 Image pickup element
4a Image pickup surface
5a, 5b Diaphragm member
8 Light blocking member
8a Plate
8b Coating
A Optical axis
C Opening edge
D Pupil position
E Corner portion (end edge)

1. A stereoscopic optical system comprising:
two objective optical systems that are arrayed parallel to each other with a space therebetween to collect a light from an object side;
two parallelogram prisms that bring optical images close to each other by respectively deflecting the lights collected by the objective optical systems twice;
an image pickup element that is arranged at image formation positions of the light fluxes collected by the objective optical systems to take the two optical images brought close to each other by the parallelogram prisms; and
a diaphragm member that blocks a portion of the light flux on at least one of an inner side and an outer side in a direction of the space between the objective optical systems at any position apart from a pupil position of each of the objective optical systems in a direction of an optical axis, wherein
the diaphragm member is arranged on the inner side in the direction of the space between the objective optical systems, and satisfies a following conditional expression:
L0−Ihy−W>Z0×sin θ
where L0 is a bend distance of the light flux by the parallelogram prism,
Ihy is an image height at an image pickup surface of the image pickup element,
W is an opening width from the optical axis to an opening edge in the diaphragm member,
Z0 is a distance from the diaphragm member to the image pickup surface in the direction of the optical axis, and
θ is an angle formed between a line and the optical axis, the line connecting the pupil position and the image height of the optical image at the image pickup surface.

2. The stereoscopic optical system according to claim 1, wherein the diaphragm member blocks a light entering at an angle equal to or more than a half view angle of 25°.

3. The stereoscopic optical system according to claim 1, wherein the diaphragm member is arranged on the outer side in the direction of the space between the objective optical systems, and satisfies a following conditional expression:
W<D0×sin θ
where W is an opening width from the optical axis to an opening edge in the diaphragm member,
D0 is a distance from the pupil position to the diaphragm member in the direction of the optical axis, and
α is an angle formed between a light flux and the optical axis, the light flux being deflected twice within the parallelogram prism from a corner on the outer side in the direction of the space in a surface of the parallelogram prism opposing the image pickup element and passing through the pupil position.

4. The stereoscopic optical system according to claim 1, further comprising a light blocking member that covers end edges of the two parallelogram prisms adjacent to each other in a substantially center of the image pickup element against the image pickup surface of the image pickup element.

5. The stereoscopic optical system according to claim 4, wherein the light blocking member is formed by depositing a coating made of a material absorbing light on a surface of a plate made of a transparent material that is bonded so as to cover the image pickup surface of the image pickup element.
